(19) United States
(12) Patent Application Publication
(10) Pub. No.: US 2010/0257985 A1
(43) Pub. Date: Oct. 14, 2010

(54) APPARATUS FOR MEASURING AND METHODS OF USING APPARATUS FOR MEASURING

(76) Inventor: Cindy Hall, Follansbee, WV (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/650,014

(22) Filed: Dec. 30, 2009

Related U.S. Application Data
(60) Provisional application No. 61/141,378, filed on Dec. 30, 2008.

(51) Int. Cl. G01B 1/00; G01B 11/14; B26D 1/00

(52) U.S. Cl. 83/13; 33/263; 33/227; 33/274

(57) ABSTRACT

Embodiments of the present disclosure include an apparatus for measuring paper for the scrapbooker. Embodiments of the present disclosure include methods of use of an apparatus for measuring paper for the scrapbooker.

### CROSS REFERENCE TO RELATED APPLICATION

This application claims priority to co-pending U.S. provisional application entitled “Apparatus for Measuring and Cutting and Methods of Using Apparatus for Measuring and Cutting,” having Ser. No. 61/141,378, filed Dec. 30, 2008, which is entirely incorporated herein by reference.

### BACKGROUND

Preserving personal and family history through scrapbooking is a favorite hobby to many. Scrapbooking hobbyist, often referred to as “scrappers” or “scrapbookers” frequently get together at their homes or attend scrapbooking classes to pursue their hobby. As such, scrapbookers require materials and tools that are easy to transport and quick and easy to use. Basic scrapbooking materials include, but are not limited to, items such as paper, paper cutters, mounting glues, rubber stamps, and craft punches.

Many scrapbooking projects involve cutting the standard 12 inch by 12 inch paper stock into various sizes of squares or rectangles. Consequently, scrapbookers require a readily transportable measuring and/or cutting tool. Currently available cutting and/or measuring tools, however, are either difficult to use, difficult to transport, or both. There are many cutters available to the scrapbooker for cutting shapes and letters, however, they require the scrapbooker to read a ruler and have some knowledge of fractions. Basic plastic cutters consist of a ruler that is difficult to read.

Thus, a need exists in the industry to overcome at least these deficiencies and shortcomings.

### SUMMARY

Embodiments of the present disclosure include a measuring apparatus for the scrapbooker.

Briefly described, embodiments of the present disclosure include an apparatus for measuring, comprising a base, where the base comprises a length and where the length comprises a shaft; a visual indicator, where the visual indicator is horizontally movable about the shaft; a user input interface, wherein the user input interface is connected to the base; and a processor, where the processor converts a user input into linear motion of the visual indicator along the shaft.

Briefly described, embodiments of the present disclosure include a measuring apparatus for the scrapbooker comprising a base, wherein the base comprises a length and wherein the length comprises a shaft and a straight edge; a visual indicator, wherein the visual indicator is horizontally movable about the shaft; a user input interface, wherein the user input interface is connected to the base; a processor, wherein the processor converts a user input into linear motion of the visual indicator along the shaft; and means for affixing the straight edge of the base to a cutter.

Briefly described, embodiments of the present disclosure include a method of using an apparatus for measuring paper, comprising pressing a “zero” key on a user input interface; affixing a cutter to the apparatus for measuring so that a groove in the base of the cutter is aligned with a first line generated by a visual indicator on the measuring apparatus, keying in a desired measurement into the user input interface; pressing an “enter” key on the user input interface, where the desired measurement will appear on a display screen located on the user input interface, lining up a piece of paper with a second line generated by the visual indicator, and cutting the paper.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an embodiment of the present disclosure where a magnet is attached to the base of the measuring apparatus in order to magnetically connect the apparatus to a cutter.

FIG. 2 illustrates an embodiment of the present disclosure where a piece of steel is affixed to a cutter in order to magnetically connect the measuring apparatus to the cutter.

FIG. 3 illustrates an example of a cutter to which an embodiment of the present disclosure may be attached.

FIG. 4 illustrates a location to which a cutter may be affixed to the measuring apparatus in an embodiment of the present disclosure.

FIG. 5 illustrates an embodiment of the present disclosure where the measuring apparatus is affixed to a cutter and aligned to begin measuring and/or cutting.

FIG. 6 illustrates an embodiment where a display screen on the user input interface guides/prompts a user of the measuring apparatus.

FIG. 7 illustrates an embodiment of a method of use of the measuring apparatus where the apparatus indicates a line at a distance from the cutting blade corresponding to a measurement keyed by a user into the user input interface.

FIG. 8 is a schematic view in accordance with an embodiment of the present disclosure.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the apparatus disclosed and claimed herein. Efforts have been made to ensure accuracy with respect to numbers, but some errors and deviations should be accounted for.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

Embodiments of the present disclosure include an apparatus for measuring and methods of using an apparatus for measuring. Embodiments of the present disclosure include an apparatus for measuring paper (e.g., card stock, designer paper, patterned paper, double sided paper) for the scrapbooker. Embodiments of the present disclosure include methods of use of an apparatus for measuring (e.g., measuring paper) for the scrapbooker.

In an embodiment of the present disclosure, the scrapbooker may quickly and easily measure paper to specific dimensions without an ability to read and/or interpret a ruler. Specifically, embodiments of the present disclosure enable the scrapbooker to measure, and thereby cut, an about 12 inch by 12 inch paper stock into various sizes of squares or rectangles. In an embodiment, the apparatus for measuring may be used to measure and/or cut paper that is smaller than about 12 inches by 12 inches into various sizes of squares or rectangles. In an embodiment, the apparatus for measuring may be used to measure and/or cut paper that is larger than about 12 inches by 12 inches into various sizes of squares or rectangles. In another embodiment, the apparatus for measuring may be used to measure and/or cut paper into numerous different shapes and/or sizes (e.g., triangles).

Embodiments of the present disclosure include an apparatus that is small (e.g., the size of a standard ruler with a key pad at one end) and light weight (e.g., weighing from only about a few ounces to about a few pounds, depending on the materials used) so that it is easily portable. The apparatus may be battery operated (e.g., 9 volt battery), so that it does not require an electrical outlet for use. However, the apparatus may be used with an AC power supply 14. In addition, embodiments of the present disclosure allow the scrapbooker to measure and/or cut paper to specific dimensions without the use of or ability to read and/or interpret a ruler.

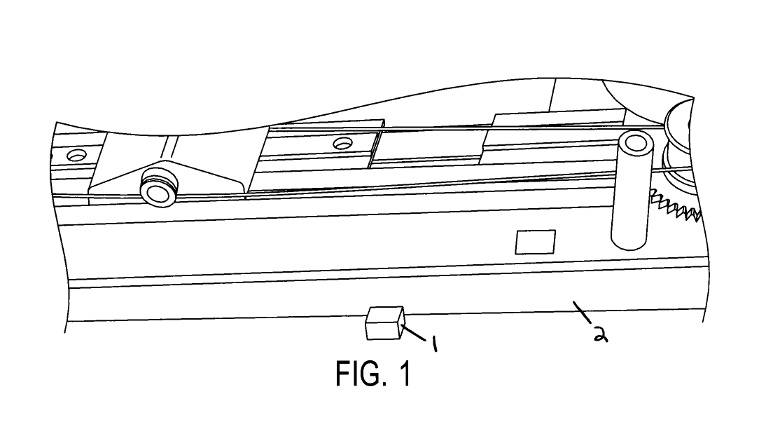

With reference to FIG. 1, an embodiment of the present disclosure allows for the measuring apparatus to be affixed to any portable cutter for the scrapbooker by a magnet 1 attached to the base 2. However, one skilled in the art would understand that any means of creating a secure/stable attachment of the base of the measuring apparatus to a cutter is feasible.

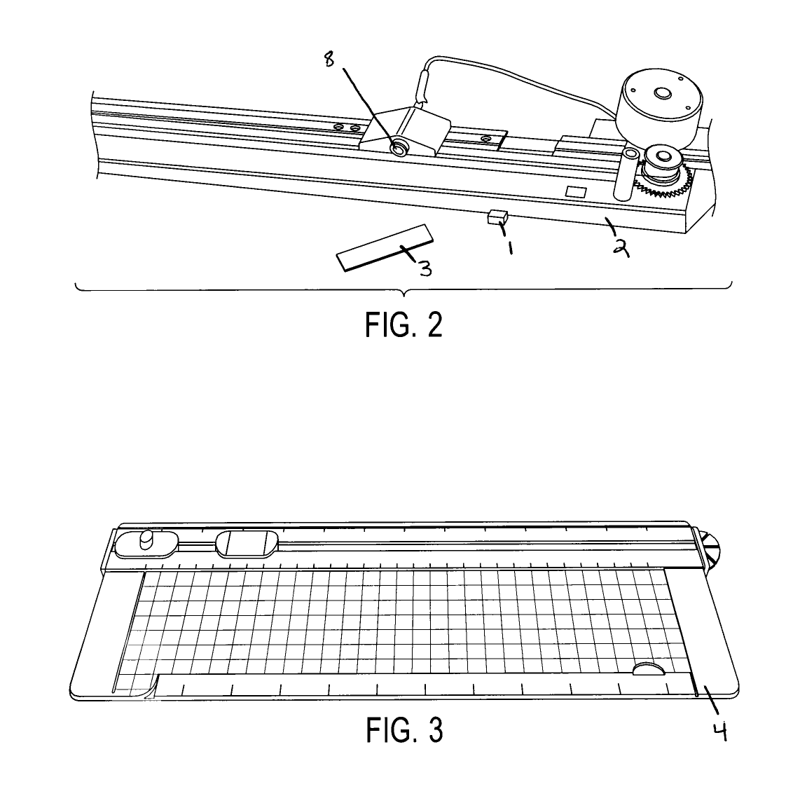

With reference to FIG. 2, a piece of steel 3 may be affixed to any cutter so that it can be affixed to the measuring apparatus via the magnet 1.

With reference to FIG. 3, any portable cutter 4 for the scrapbooker may be affixed to the measuring apparatus. The cutter may be affixed to the measuring apparatus so that the groove in which the blade moves for cutting is aligned with a line generated by the visual indicator of the measuring apparatus when the “zero” key is pressed by a user.

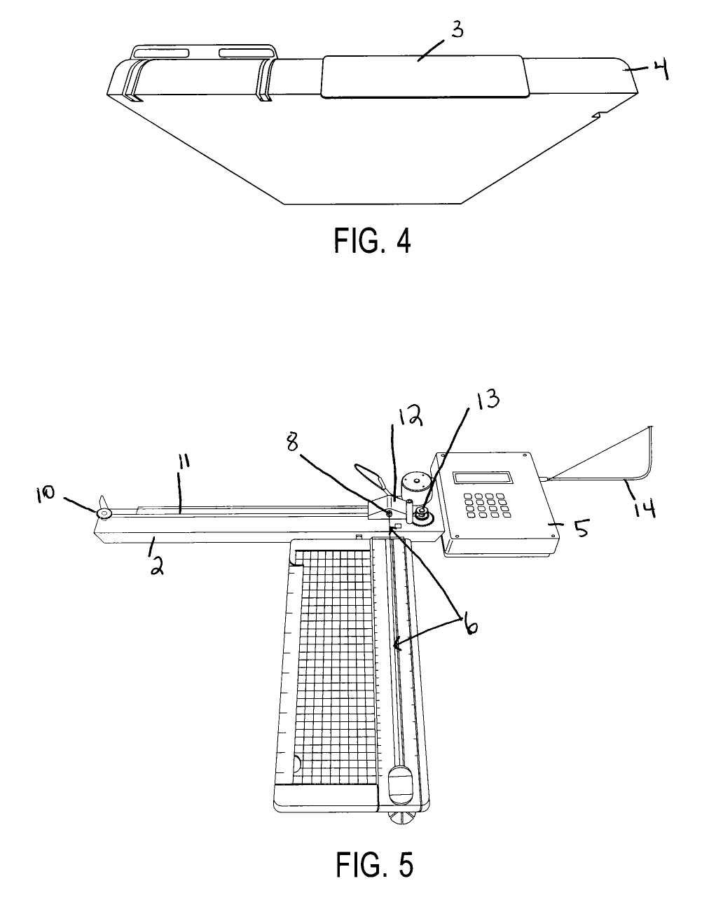

With reference to FIG. 4, because most cutters for the scrapbooker are made of plastic, a piece of steel 3 may be affixed to the side of the cutter 4 so that it may be magnetically attached to the measuring apparatus.

With reference to FIG. 5, when the “zero” key is pressed by a user of the measuring apparatus, a line 6 is generated by the visual indicator so that a user my properly align any cutter with the measuring apparatus for accurate measurements.

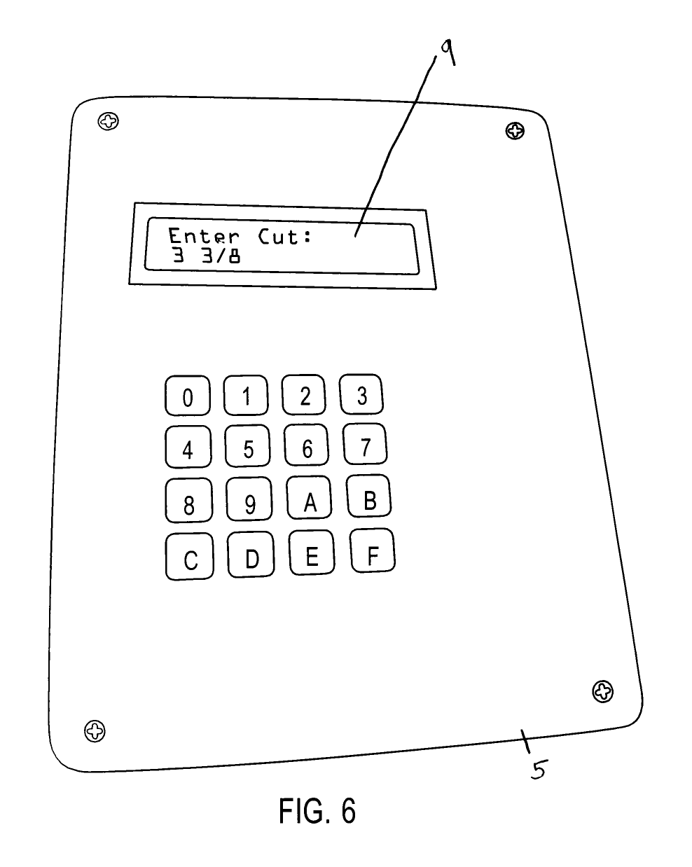

With reference to FIG. 6, a user input interface 5 includes a plurality of keys including whole numbers 0 to 12 (or may only include only whole numbers 0 to 9), and representing “enter”, “clear”, “/”, “on/off”, and “zero” (may be any of keys labeled A through F). However, the “on/off” power key may be at a different location of the measuring apparatus (e.g., on the side of the apparatus rather than as one of the keys on the user input interface).

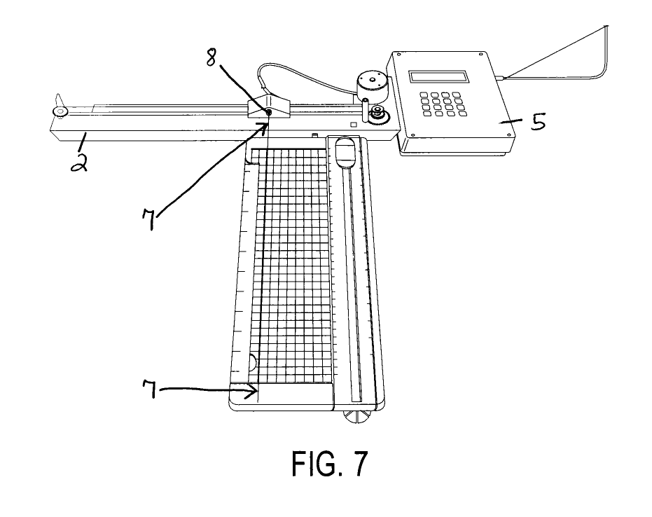

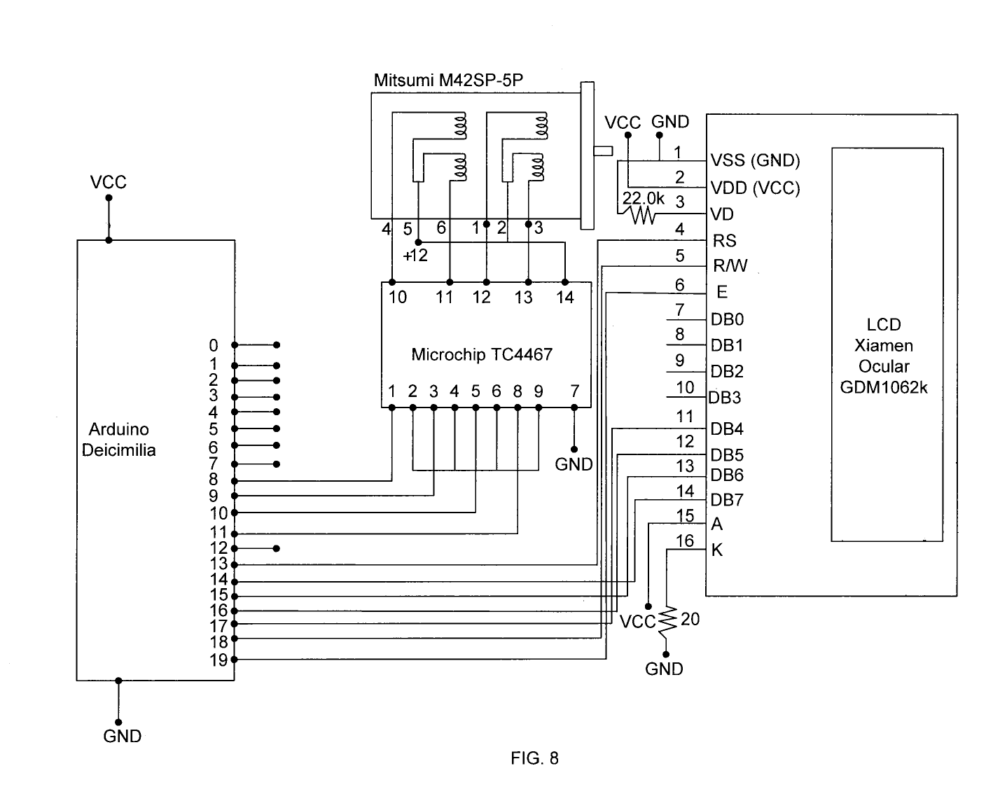

With reference to FIG. 7, once a user keys in the desired measurement/dimension and presses the “enter” key, the visual indicator moves along the length of the measuring apparatus and generates a line 7 at which the user will line up the paper to be cut.

Embodiments of the present disclosure include an apparatus for measuring comprising: a base, wherein the base comprises a length and wherein the length comprises a shaft; a visual indicator, wherein the visual indicator is horizontally movable about the shaft; a user input interface, wherein the user input interface is connected to the base; and a processor, wherein the processor converts a user input into linear motion of the visual indicator along the shaft. In an embodiment, the user input interface receives inputs of measurement in a format corresponding to the unit of measurement in which the visual indicator moves along the shaft. In another embodiment, the shaft comprises a bar (e.g., a steel bar) along which the visual indicator moves.

Embodiments of the present disclosure include an apparatus for measuring where the visual indicator comprises a laser housed in a carriage. In an embodiment, the laser comprises a line generating lens perpendicular to the direction of travel.

Embodiments of the present disclosure include an apparatus for measuring where the apparatus is comprised of a light-weight material. In an embodiment, the light-weight material is selected from the group consisting of: plastic and steel.

Embodiments of the present disclosure include an apparatus for measuring where the user input interface comprises a keypad and display screen. In an embodiment, the display screen comprises a LCD screen. In another embodiment, the keypad comprises a plurality of keys includes keys representing whole numbers from 0 to 12. In another embodiment, keys representing whole numbers 0 to 9 are included. In another embodiment, the plurality of keys includes keys representing “enter”, “clear”, “/”, “on/off”, and “zero.”

Embodiments of the present disclosure include a method of using an apparatus for measuring and cutting paper, comprising: pressing a “zero” key on a user input interface; affixing a cutter to the apparatus for measuring so that a groove in the base of the cutter is aligned with a first line generated by a visual indicator on the measuring apparatus; keying in a desired measurement into the user input interface; pressing an “enter” key on the user input interface, wherein the desired measurement will appear on a display screen located on the user input interface; lining up a piece of paper with a second line generated by the visual indicator; and cutting the paper. In an embodiment the first line is generated by the measuring apparatus when a user presses the “zero” key. In another embodiment, the second line is generated when a user enters a numerical measurement (e.g., in inches, either a whole number and/or a fraction) and presses the “enter” key. The second line is generated a distance from the zero line (at which the blade of the cutter is aligned) corresponding to the measurement entered by the user.

In an embodiment of the present disclosure, when the “enter” key is pressed by the user (after keying in a measurement), the display of the user interface reads “Moving to the desired cut.” In another embodiment, once the visual indicator reaches the desired distance from the zero point and generates the second line, the display of the user interface reads “Align the paper and make the cut.”

In an embodiment of the present disclosure, the user input interface receives user inputs of measurement and the laser moves about the bar a distance corresponding to that measurement. The measuring apparatus of the present disclosure measures in inches, however, it is possible for the apparatus to measure in other units of measurement (e.g., centimeters).

The laser creates the visual indicator of measurement. However, other types of indicators could be used (e.g., any light/illuminating source). The visual indicator moves a distance from its starting position (i.e., zero position) corresponding to the measurement entered into the user input interface. Embodiments of the present disclosure include user inputs corresponding to whole numbers or fractions of numbers.

The measuring apparatus of the present disclosure may be used with any portable line cutter or folder (e.g., Cricut Tirmmer model 29-0012). In an embodiment, the measuring apparatus is attached (e.g., connected) to a cutter. In another embodiment, the measuring apparatus is magnetically attached to a cutter. The base of the measuring apparatus may comprise at least one magnet of any practical size and/or shape. In addition, a piece of steel may be adhered to the cutter in order to attach it to the measuring apparatus via the magnet. One of skill in the art would understand that the magnet/steel method of attachment is merely one possibility and that any practical method of producing a secure/stable attachment is contemplated by the present disclosure.

Embodiments of the present disclosure comprise a measuring apparatus comprising: a base; a motor (e.g., a geared down stepper motor, e.g., Mitsumi model M42SP-5P); a spindle driving a cable belt, where the spindle driving cable belt drives a small carriage carrying a laser; a laser, wherein the laser comprises a line generating lens perpendicular to the direction of travel; a carriage, wherein the carriage houses the laser; a keypad; and a display screen. In an embodiment, the entire measuring apparatus may be housed in plastic in a rectangular shape resembling a ruler (e.g., a rectangular shape comprising a length, width, and thickness). In another embodiment, the plastic housing includes measurement markings of a ruler. In another embodiment, the motor may operate in 7.5 degree steps.

The measuring apparatus of the present disclosure includes a visual indicator of measurement (e.g., a laser) that is housed in a carriage and horizontally moveable about at least one guide shaft (e.g., a stainless steel bar). The measuring apparatus of the present disclosure may include at least one idler at either end of the guide shaft. In an embodiment, at least one capstan may be included at one end of the shaft (FIG. 5).

Embodiments of the present disclosure include a measuring apparatus that uses a geared down stepper motor (e.g., Mitsumi model M42SP-5P), which operates in about 7.5 degree steps. However, the linear translation stage may be accomplished with a stepper motor screw drive, a common DC gear motor and a rotary encoder, or any other linear motion translation device. Line accuracy to about 1/32 of an inch may be realized.

In an embodiment, the measuring apparatus of the present disclosure may include a USB port (Universal Serial Bus), which may be used to download a series of measurements for future software enhancements.

The user input interface of the present disclosure includes a keypad and a display screen. In an embodiment, the keypad includes a plurality of keys representing whole numbers from 0 to 12. In another embodiment, the plurality of keys includes keys representing “enter”, “clear”, “/”, “on/off”, and “zero.” In another embodiment, keys representing “+” and “−” are included in order to quickly and easily decrease or increase measurement inputs. In an embodiment, the “zero” key, when pressed by the user, directs the visual indicator to return to its zero position (i.e., resting position) which is the position where the groove in which the blade of the cutter is aligned. In another embodiment, the user of the apparatus attaches a line cutter to the measuring apparatus so that the groove in the base of the cutter is aligned with the visual indicator in its resting position.

Embodiments of the present disclosure include an apparatus for measuring, where the display screen 9 of the user input interface is a liquid crystal display (LCD) screen. In an embodiment, the display screen may be movable in at least one direction for visual ease of use.

Embodiments of the present disclosure include a method for measuring and cutting paper comprising: switching the apparatus on via an on/off switch/key; entering a measurement in the form of a number of inches followed by a fraction of an inch; lining up paper (e.g., paper stock) with the line indicated by the measuring apparatus via the laser; and cutting the paper.

### EXAMPLES

### Introduction

Numerous types of cutters are available to the scrapbooker for cutting shapes and letters, but none allow a user to cut paper (e.g., card stock) to specific dimensions without manually reading/interpreting a ruler and having some knowledge of fractions. The measuring apparatus of the present disclosure fills a need by indicating a physical measurement that is entered into a user interface (e.g., a keypad) by a user without the use of or ability to read and/or interpret a ruler. In addition, the measuring apparatus of the present disclosure is easily transportable and light weight, allowing the scrapper to take it to classes and crops. It may operate on replaceable batteries, or an optional AC power supply.

### Discussion

The measuring apparatus of the present disclosure is intended to be used with any line cutter or folder (e.g., a standard portable cutter), even those that already incorporate their own manually read ruler. The measuring apparatus may include a magnet 1 attached to a base 2 (FIGS. 1 and 2). A flat piece of steel 3 may then be affixed to any cutter (FIGS. 2 and 4) so that the measuring apparatus may be magnetically attached to the cutter (FIG. 5).

A laser 8 generates a line 6 with which the blade of a cutter is aligned (i.e., the resting position of the laser is lined up with the groove in the base of the cutter in which the blade travels) (FIG. 5). A display screen 9 on a user interface 5 guides (e.g., prompts) the user of the measuring apparatus (FIG. 6).

Basic Operation

A user of the measuring apparatus keys in a measurement in the form of a whole number of inches followed by a fraction of an inch (depending on the size needed). The measuring apparatus then indicates the measurement keyed in by the user via a line created by a laser at the specified distance from the cutting blade. The user of the apparatus may then line the paper up with the line indicated and cut the paper with the blade of the cutter (FIG. 7). I user may then clear the display by pressing the “clear” key and enter another measurement by keying in the numerical measurement and pressing “enter.” The user may then rotate the paper so that another dimension may be measured/cut.

Advanced Operation

The method of entry on the user input interface is a keypad which comprises keys indicating whole numbers 0-12, “enter”, “clear”, “/” (for fractions), “on/off”, and “zero” (FIG. 6). The device is first activated with the “on” key (or an “on/off” button/switch in a different location of the apparatus). After zeroing, the display screen of the user input interface then requests the measurement by displaying “enter cut:”. The desired measurement in a unit of inches is entered (2 digits max), and the “enter” key is pressed. The user is then directed/prompted to enter the fractional inch in the form of numerator, “/”, then denominator. Any fraction can be entered, but the fraction will be dismissed if the numerator is greater than the denominator, and must be re-entered. At the end of this sequence, the user presses “enter” at which point the visual indicator (e.g., laser) moves to the entered distance from the blade of the cutter, and the user is instructed (e.g., the display reads “Align the paper and make the cut”) to line his/her paper up with the visual indicator (e.g., laser line) and operate the cutter blade.

In an embodiment of the present disclosure, the apparatus uses a geared down stepper motor (e.g., Mitsumi model M42SP-5P), which operates in 7.5 degree steps. This is then geared down at a 12.5:1 ratio to a spindle driving a cable belt which drives a small carriage 12 carrying a laser 8 (e.g., a Quaron laser line module VLM-635-27-LPA). The laser is shown through a line generating lens which has been aligned to be perpendicular with the direction of travel. Limits are placed in software to yield a 1/32 inch line accuracy. The linear translation stage is accomplished with a geared down stepper driven belt, but the same effect could be realized with a stepper motor screw drive, a common DC gear motor and a rotary encoder, or any other linear motion translation device. In addition, an embodiment of the present disclosure includes a USB port, which could be used to download a series of measurements into the electronic ruler for future software enhancements.

An embodiment of the present disclosure includes a nylon idler (0.500), lip (0.750), and hole 10 (0.125 with a #6 machine screw) at one end of the shaft 11 (e.g., a 0.250 stainless steel bar that is about 14.5 inches in length) (FIG. 5). At the opposite end of the shaft, an embodiment of the apparatus comprises a capstan (0.500), lip (0.750), a hole with E clip (0.250), and a nylon gear 13 (1.125) (FIG. 5). The base of the apparatus which houses the shaft (e.g., bar) may be about 15 inches in length. The user input interface may comprise a keypad, stepper motor, and LCD display.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In embodiments where “about” modifies 0 (zero), the term “about” can include ±1%, ±2%, ±3%, ±4%, ±5%, ±6%, ±7%, ±8%, ±9%, ±10%, or more of 0.00001 to 1. In addition, the phrase “about ‘x’ to ‘y’” includes “about ‘x’ to about ‘y’”.

It should be emphasized that the above-described embodiments of the present disclosure are merely possible examples of implementations, and are merely set forth for a clear understanding of the principles of the disclosure. Many variations and modifications may be made to the above-described embodiments. All such modifications and variations are intended to be included herein within the scope of this disclosure and protected by the following claims.

Therefore, at least the following is claimed:

1. An apparatus for measuring, comprising:
a base, wherein the base comprises a length and wherein the length comprises a shaft;
a visual indicator, wherein the visual indicator is horizontally movable about the shaft;
a user input interface, wherein the user input interface is connected to the base; and
a processor, wherein the processor converts a user input into linear motion of the visual indicator along the shaft.

2. The apparatus for measuring of claim 1, wherein the visual indicator comprises a laser housed in a carriage.

3. The apparatus for measuring of claim 2, wherein the laser comprises a line generating lens perpendicular to the direction of travel.

4. The apparatus for measuring of claim 1, wherein the apparatus is comprised of a light-weight material.

5. The apparatus for measuring of claim 1, wherein the light-weight material is selected from the group consisting of: plastic and steel.

6. The apparatus for measuring of claim 1, wherein the user input interface comprises a keypad and display screen.

7. The apparatus for measuring of claim 6, wherein the display screen comprises a LCD screen.

8. The apparatus of claim 6, wherein the keypad comprises a plurality of keys includes keys representing whole numbers from 0 to 12.

9. The apparatus of claim 6, wherein the plurality of keys includes keys representing “enter”, “clear”, “/”, “on/off”, and “zero.”

10. The apparatus of claim 1, wherein the base of the apparatus is affixed to a cutter.

11. The apparatus of claim 1, wherein the length comprises a shaft and a straight edge.

12. The apparatus of claim 1, wherein a scrapbooker can measure paper to specific dimensions without an ability to read and/or interpret a ruler.

13. A measuring apparatus for the scrapbooker comprising:
a base, wherein the base comprises a length and wherein the length comprises a shaft and a straight edge;
a visual indicator, wherein the visual indicator is horizontally movable about the shaft;
a user input interface, wherein the user input interface is connected to the base;
a processor, wherein the processor converts a user input into linear motion of the visual indicator along the shaft; and
means for affixing the straight edge of the base to a cutter.

14. The measuring apparatus for the scrapbooker of claim 13, wherein the apparatus is housed in plastic with a size and shape to resemble a traditional ruler.

15. A method of using an apparatus for measuring paper, comprising:
pressing a “zero” key on a user input interface;
affixing a cutter to the apparatus for measuring so that a groove in the base of the cutter is aligned with a first line generated by a visual indicator on the measuring apparatus;
keying in a desired measurement into the user input interface;
pressing an “enter” key on the user input interface, wherein the desired measurement will appear on a display screen located on the user input interface;
lining up a piece of paper with a second line generated by the visual indicator; and
cutting the paper.
